(19) United States
(12) Patent Application Publication
(10) Pub. No.: US 2025/0245855 A1
(43) Pub. Date: Jul. 31, 2025

(54) POSE-BASED THREE-DIMENSIONAL STRUCTURE RECONSTRUCTION SYSTEMS AND METHODS

(71) Applicant: INTUITIVE SURGICAL OPERATIONS, INC., Sunnyvale, CA (US)

(72) Inventors: Jorge Anton Garcia, San Francisco, CA (US); Federico Barbagli, San Francisco, CA (US); Shiyang Chen, Sunnyvale, CA (US); Trevor Laing, San Jose, CA (US); Hui Zhang, San Jose, CA (US)

(21) Appl. No.: 18/853,978

(22) PCT Filed: Mar. 31, 2023
(86) PCT No.: PCT/US2023/017095

§ 371 Date: Oct. 3, 2024

Related U.S. Application Data
(60) Provisional application No. 63/327,119, filed on Apr. 4, 2022.

(51) Int. Cl. G06T 7/73; G06T 7/55; G06T 11/00

(52) U.S. Cl. CPC G06T 7/75; G06T 7/55; G06T 11/005; G06T 2207/10121; G06T 2207/30004; G06T 2207/30244

(57) ABSTRACT

Three-dimensional structure reconstruction systems and related methods are disclosed. In some examples, a three-dimensional structure reconstruction system may include at least one processor configured to: receive a time-ordered plurality of X-ray images of an object, where the plurality of X-ray images are taken at a plurality of poses relative to the object, where at least one of the plurality of X-ray images depicts at least one object of known shape and/or location; determine an initial estimate of at least one pose of at least one of the plurality of X-ray images; and refine the at least one pose based on at least one comparison with the plurality of X-ray images. In some examples, a method may include receiving time-ordered images taken at poses; determining an initial estimate of at least one pose; and refining a pose based on at least one comparison with the plurality of X-ray images.

### CROSS-REFERENCED APPLICATIONS

This application claims priority to and benefit of U.S. Provisional Application No. 63/327,119, filed Apr. 4, 2022 and entitled “Pose-Based Three-Dimensional Structure Reconstruction Systems and Methods,” which is incorporated by reference herein in its entirety.

### FIELD

Disclosed examples are related to three-dimensional structure reconstruction systems and methods.

### BACKGROUND

C-arm machines are often used to take X-rays of a patient on a platform. Manual C-arm machines permit an operator to manually rotate the C-arm around a patient to get images at various positions and orientations relative to a subject.

### SUMMARY

In one example, a three-dimensional structure reconstruction system may comprise at least one processor configured to: receive a time-ordered plurality of X-ray images of an object, wherein the plurality of X-ray images are taken at a plurality of poses relative to the object, wherein at least one of the plurality of X-ray images depicts at least one object of known shape and/or location; determine an initial estimate of at least one pose of at least one of the plurality of X-ray images; and refine the at least one pose based on at least one comparison with the plurality of X-ray images.

In another example, at least one non-transitory computer-readable medium may have instructions thereon that, when executed by at least one processor, perform a method for three-dimensional structure reconstruction, the method comprising: receiving a time-ordered plurality of X-ray images of an object, wherein the plurality of X-ray images are taken at a plurality of poses relative to the object, wherein at least one of the plurality of X-ray images depicts at least one object of known shape and/or location; determining an initial estimate of at least one pose of at least one of the plurality of X-ray images; and refining the at least one pose based on at least one comparison with the plurality of X-ray images.

In yet another example, a method for three-dimensional structure reconstruction may comprise: receiving a time-ordered plurality of X-ray images of an object, wherein the plurality of X-ray images are taken at a plurality of poses relative to the object, wherein at least one of the plurality of X-ray images depicts at least one object of known shape and/or location; determining an initial estimate of at least one pose of at least one of the plurality of X-ray images; and refining the at least one pose based on at least one comparison with the plurality of X-ray images.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting examples when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A depicts an illustrative C-arm imaging system, in accordance with embodiments of the present disclosure.

FIG. 1B depicts an illustrative imaging system being operated with a subject in place, in accordance with embodiments of the present disclosure.

FIG. 2 is a block diagram showing a schematic representation of an imaging system with a flexible medical system including a shape sensor disposed within the field of view of an imaging system, in accordance with embodiments of the present disclosure.

FIG. 3 depicts an illustrative flexible, elongate device visualized in some contexts, in accordance with embodiments of the present disclosure.

FIG. 4A is the first part of a flowchart illustrating a method used to reconstruct a three-dimensional structure, in accordance with embodiments of the present disclosure.

FIG. 4B is the second part of the flowchart shown in FIG. 4A.

FIG. 5 is a flowchart illustrating a method used to reconstruct a three-dimensional structure, in accordance with embodiments of the present disclosure.

FIG. 6 depicts an illustrative bundle adjustment, in accordance with embodiments of the present disclosure.

FIG. 7 depicts an illustrative C-arm imaging system including an object for calibrating distortion parameters, in accordance with embodiments of the present disclosure.

FIG. 8 is an illustration of an object for calibrating distortion parameters, in accordance with the present disclosure.

### DETAILED DESCRIPTION

In certain applications, users (such as medical practitioners) look at two-dimensional views output from a C-arm system and make educated guesses at the shapes and positions of objects and anatomical structures in the different views. However, two-dimensional fluoroscopic-images (which are often produced by these systems) have no depth information due to overlap of different portions of the three-dimensional structure within the images. As a result, it is very difficult or impossible to tell the three-dimensional relative pose of a medical tool relative to a target tissue in the subject (such as a lesion), so guesswork is often needed by users employing manual C-arm imaging systems. This is due to conventional manual two-dimensional C-arm systems not measuring or tracking the reference frame and pose of the images relative to each other unlike CT scanners and automated C-arm machines. As a result, typical image reconstruction and segmentation methods cannot be used on the stream of images taken of the subject with a conventional manual C-arm.

As such, it may be desirable to improve localization, especially of the relative position of an end portion of a medical tool (e.g., a catheter, a biopsy needle, or other desirable tool) and the target tissue during an operation (e.g., a lesion on an organ of the subject). Furthermore, it may be desirable to permit three-dimensional reconstruction and/or segmentation of objects located in the field of view of an imaging system, even if the pose of the different images relative to each other is initially unknown.

In some embodiments, a system may receive an image stream of a series of sequential two-dimensional images (such as X-ray fluoroscopic-images) captured from different sequentially arranged poses of an imaging device (e.g., the detector in a C-arm system or other type of imaging system) taken along a path of motion of the imaging device relative to a subject during image capture. As used herein, a pose of an image refers to the position and orientation of the imaging device that captured the image. Each image is captured from a perspective that is defined by the pose of the imaging device at the time of capture. These images may be used to reconstruct the three-dimensional structures within the subject being imaged, including, for example, a portion of a subject's body and an associated instrument interacting with the subject's body. However, to use the image stream, it is desirable to know the pose of the imaging device associated with each image captured by the imaging device. In view of this limitation associated with typical imaging devices, having an object of known shape and/or location in the field of view of the imaging device can be used to determine the poses associated with the different images of the image stream. Specifically, at least one comparison with the plurality of images of the image stream may be used to refine one or more estimated poses of the image stream. In some embodiments, the comparison may include generating one or more two-dimensional projected images of at least a portion of the object that are projected using the initial pose estimates. The resulting projected images may be compared with the corresponding images of the image stream to provide a refined pose estimation for at least one of the poses as detailed further below. The resulting poses may optionally be used in combination with the captured images for any desired application including use with any appropriate reconstruction algorithm.

Any appropriate type of shape sensor capable of sensing a shape of at least a portion of an instrument disposed within a field of view of an imaging system may be used with the various embodiments disclosed herein. Appropriate types of shape sensors may include, but are not limited to, optical fiber shape sensors, encoder/displacement sensors of an articulable instrument, electromagnetic sensors positioned at known locations along the instrument, position sensors, combinations of the foregoing, and/or any other appropriate sensor configured to sense a shape, orientation, and/or location of one or more portions of an instrument.

The received images used in the various embodiments described herein may have any appropriate resolution. For example, the received images may have a resolution of at least 256 pixels by 256 pixels. In some embodiments, the received images may have a resolution of at least 512 pixels by 512 pixels. In some embodiments, the received images may have a resolution of at most 976 pixels by 976 pixels or 1200 pixels by 1200 pixels. For example, the received images may have a resolution of between or equal to 256 pixels by 256 pixels and 976 pixels by 976 pixels. While specific resolutions are noted above any appropriate resolution may be used for the images described herein.

A reconstructed structure may have any appropriate resolution. For example, a reconstructed structure may have a voxel resolution of at least 256 voxels by 256 voxels by 256 voxels. In some embodiments, the reconstructed structure may have a voxel resolution of at least 512 voxels by 512 voxel is by 512 voxels. In some embodiments, the reconstructed structure may have a resolution of at most 976 voxels by 976 voxels by 976 voxels. For example, the reconstructed structure may have a resolution between or equal to 256 voxels by 256 voxels by 56 voxels and 976 voxels by 976 voxels by 976 voxels. While specific resolutions for a reconstructed structure are noted above, any appropriate resolution may be used.

In the various embodiments disclosed herein, a C-arm 110 may be configured to rotate through any suitable range of angles. For example, typical C-arms may be configured to rotate up to angles between or equal to 140 degrees and 270 degrees around an object, e.g., a subject on an imaging table. As elaborated on further below, in some embodiments, scans can be conducted over an entirety of such a rotational range of a C-arm. Alternatively, scans can be conducted over a subset of the rotational range of the system that is less than a total rotational range of the system. For example, a scan might be conducted between 0 degrees and 90 degrees for a system that is capable of operating over a rotational range larger than this. While specific rotational ranges are noted above, the systems and methods disclosed herein may be used with any appropriate rotational range. The quality of reconstruction may increase as the range of rotation is increased, and the techniques described herein allow as much rotation as an operator desires.

Some embodiments may be widely usable and applicable with simple and commonly used inputs from manually operated C-arm machines. Some embodiments may operate even without additional hardware. For example, some embodiments could be installed as part of the scanner's firmware or software, or used independently by transferring the images to whatever device hosts the algorithm. Thus, the disclosed embodiments may provide an inexpensive alternative to automated three-dimensional C-arms, which are less common and significantly more expensive than a manual two-dimensional C-arm machine. In some embodiments, no additional sensors or fiducial markers are needed for any of these processes.

Furthermore, manually rotated C-arms have varying trajectories between runs, and so techniques determining where on the trajectory the C-arm is using a rotation sensor only may not be sufficient to provide acceptable reconstruction. Some embodiments herein may correct for these varying trajectories, and may detect the higher amount of jitter caused in manual motion, such as by accurately detecting the pose of the source and detector of the C-arm on a per-image basis.

It may be desirable to improve an accuracy of an initial estimate of the poses of the stream of images used in the disclosed methods and systems. In such an embodiment, a pose sensor configured to sense a parameter related to an estimated pose of the system during imaging may be used. In some instances this may correspond to one or more addon pose sensors that are added to an existing imaging system. For example, appropriate pose sensors may include, but are not limited to an inertial measurement unit (IMU), an accelerometer, a gyroscope, a magnetometer, an encoder, a gravitometer, a camera pointing to the surrounding environment (SLAM), an optical tracker (e.g., a camera pointing at the C-Arm), a combination of the above, and/or any other appropriate type of pose sensor capable of sensing a parameter related to a pose of the system relative to an object during imaging. Such a sensor may improve estimates using data related to poses of the images, and that using such additional hardware, especially an inexpensive add-on sensor, may still greatly limit costs relative to conventional automated three-dimensional C-arms.

While specific dimensions and ranges for various components and aspects of the systems and methods disclosed herein are described both above and elsewhere in the current disclosure, dimensions both greater than and less than those noted herein may be used.

Embodiments herein may be used with the imaging and localization of any medical device, including robotic assisted endoscopes, catheters, and rigid arm systems used in a medical procedure. For example, the disclosed methods and systems may be used to provide updated pose information that may enable the 3D reconstruction and/or segmentation of objects (e.g., a lung and medical device during a medical procedure) using inexpensive medical imaging devices (e.g., 2D fluoroscopic C-arm) with, or without, an addon sensor. The disclosed techniques are not limited to use with only these specific applications. For example, while the disclosed methods are primarily described as being used with C-arm systems used to take X-ray images at different poses relative to a subject, the disclosed methods may be used with any X-ray imaging system that takes X-ray images at different poses relative to an object being imaged by the system.

The disclosed methods and systems may offer a number of benefits relative to both automated C-arms capable of 3D reconstruction and manual C-arms which are not typically capable of 3D reconstruction. For example, the disclosed methods and systems may be used to enable 3D reconstruction and/or segmentation of a target tissue (e.g., a target with the lung or other portion of a subject's body) from the standard output of relatively inexpensive and commonly used medical imaging devices (e.g., a conventional manual two-dimensional C-arm system). The disclosed imaging systems and methods may also be used without affecting the workflow of a medical procedure relative to current systems in some embodiments. Thus, the disclosed methods and systems may be used as an alternative to a more expensive 3D C-arm imaging system within the workflow of current 2D C-arms in some embodiments. Additionally, the ability of the disclosed methods and systems to account for differences in the amount of rotation applied by a user during manual imaging may also provide a flexible imaging system, though larger ranges of rotation may be associated with improved reconstruction quality. The use of a fiducial (e.g., an object of known shape) to improve the pose estimates of the image stream may also provide a robust and accurate method for accounting for the differences in manual rotation trajectories of a system during separate manual scans. While several potential benefits are described above, other benefits different from those noted above may also be present in a system.

The received images and/or the output of the disclosed processes may correspond to any desirable format. However, in some embodiments, the received and/or output images may be in Digital Imaging and Communications in Medicine (DICOM) format. Such a format can be browsed (e.g., like a CT scan), may be widely compatible with other systems and software, and may be easily saved to storage and viewed later.

As used herein, the term “position” refers to the location of an element or a portion of an element in a three-dimensional space (e.g., three degrees of translational freedom along cartesian x-, y-, and z-coordinates). As used herein, the term “orientation” refers to the rotational placement of an element or a portion of an element (three degrees of rotational freedom—e.g., roll, pitch, and yaw, axis-angle, rotation matrix, quaternion representation, and/or the like). As used herein, the term “pose” refers to the multi-degree of freedom (DOF) spatial position and orientation of a coordinate system of interest (e.g., attached to a rigid body). In general, a pose includes a pose variable for each of the DOFs in the pose. For example, a full 6-DOF pose would include 6 pose variables corresponding to the 3 positional DOFs (e.g., x, y, and z) and the 3 orientational DOFs (e.g., roll, pitch, and yaw).

Turning to the figures, specific non-limiting examples are described in further detail. It should be understood that the various systems, components, features, and methods described relative to these examples may be used either individually and/or in any desired combination as the disclosure is not limited to only the specific examples described herein.

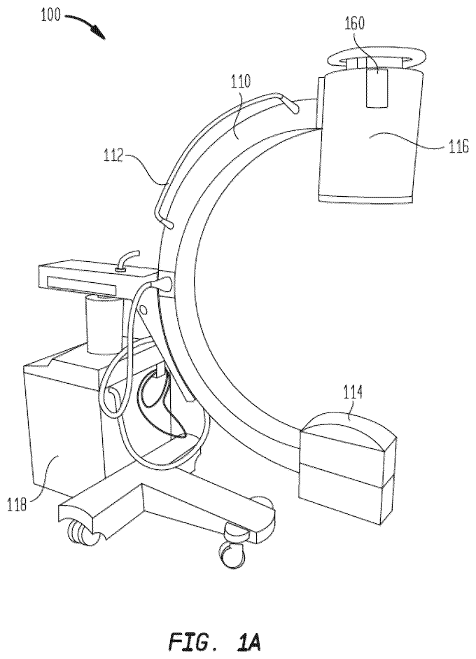

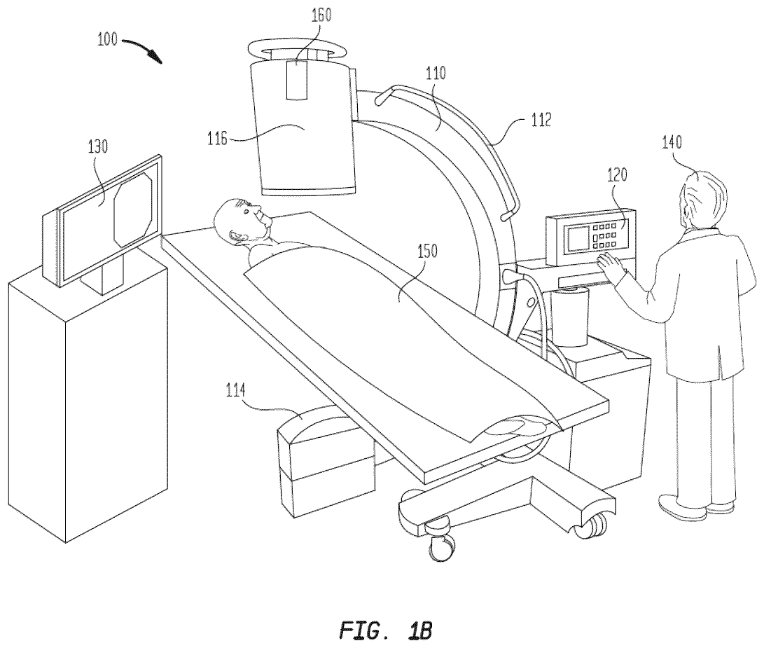

FIG. 1A depicts an illustrative two-dimensional C-arm imaging system 100, in accordance with embodiments of the present disclosure. The imaging system 100 may be configured for imaging any desired object. In examples in which the imaging system is a medical imaging system, the object to be imaged may correspond to tissue of a subject, and in some instances a medical system interacting with the target tissue. The tissue may correspond to a site within a natural cavity and/or interventional site of a subject. The imaging system 100 includes a manual C-arm 110 operatively coupled to a source 114, a detector 116, and a controller 120. In some embodiments, the source 114 may be configured to emit X-rays towards the detector 116, which may be configured to detect an X-ray image of an object disposed between the source 114 and the detector 116. In some embodiments, the controller 120 may be operatively coupled with the detector 116 such that it receives a stream of images from the detector 116. The C-arm 110 may also be rotatably coupled to a base 118 configured to support the overall C-arm imaging system. In some embodiments, the imaging system 100 includes a manual handle 112 attached to the C-arm 110 that may be used by an operator to control a pose of the C-arm 110, as well as the source 114 and the detector 116, as they are rotated relative to the base 118 and an object disposed between the source 114 and detector 116. While the embodiments disclosed herein are primarily directed to manually controlled C-arms, in some embodiments, the pose of the C-arm 110 may be controlled programmatically or by a user via a user input device

In some embodiments, the imaging system 100 may include a pose sensor 160. In some instances, the pose sensor 160 may be an addon pose sensor that is attached to an appropriate portion of the manual C-arm 110, or other imaging system, such that the pose sensor 160 may sense one or more parameters related to a pose of the source 114 and detector 116 relative to an object being imaged within a field of view of the system. The pose sensor 160 may be attached to the C-arm 110 of the imaging system 100. In other examples, a pose sensor 160 may be attached to the detector 116 and/or source 114. In some embodiments, the attachment may use adhesive, hook-and-loop, screws, bolts, or any other suitable attachment mechanism. In some embodiments, the orientation of the rotation axis of the pose sensor 160 may be aligned with the C-arm rotation axis, which may improve the accuracy of the sensor's measurements. In some embodiments, the communication between the pose sensor 160 and the controller 120 or other computer can be via Wi-Fi, Bluetooth, wired, near-field communication, or any other suitable communication method.

FIG. 1B depicts an illustrative imaging system 100 being operated with a subject 150 in place, in accordance with embodiments of the present disclosure. FIG. 1B shows a manual C-arm imaging system 100 with a C-arm 110, source 114, detector 116, and manual handle 112 similar to that described above. In some embodiments, the imaging system 100 includes a display 130. FIG. 1B also shows an illustrative operator 140 operating the manual handle 112 and an illustrative subject 150 being scanned by the imaging system 100. The source 114 and detector 116 are rotatable around the subject 150 as a pair. As noted above, the C-arm, as well as the associated detector 116 and source 114, are rotatable such that they may be rotated through a plurality of different poses relative to the subject 150, or other object disposed between the source 114 and detector 116. Thus, the source 114 and detector 116 may be used to obtain a stream of sequential x-ray images of the subject 150, or other object, at a plurality of poses relative to the subject as the C-arm 110 is manually rotated by the operator 140 between an initial and final pose. As noted above, this may correspond to rotation between any desired poses including rotation over and entire rotational range of the C-arm 110 or a portion of the rotational range of the C-arm 110. In some embodiments, the imaging system 100 may include a pose sensor 160 as described above.

In some embodiments, a pose estimation and/or three-dimensional structure reconstruction system as described herein may be part of the controller 120 of the imaging system. Alternatively or additionally, the pose estimation and/or three-dimensional structure reconstruction system may be part of a separate computer, such as a desktop computer, a portable computer, and/or a remote or local server. In some embodiments, the pose estimation and/or three-dimensional structure reconstruction system may include at least one processor, such as the controller 120.

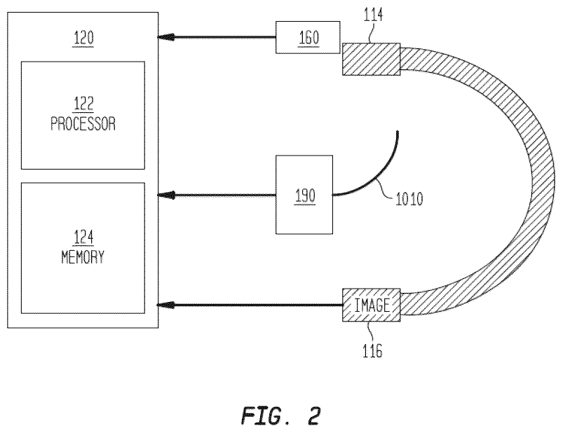

FIG. 2 is a block diagram showing relationships of one embodiment of an imaging system similar to that described above. In the depicted embodiment, the imaging system includes a source 114 and detector 116. In some embodiments, a shape sensor 190 may be configured to detect a shape, or at least a location of one or more portions, of an object 1010 disposed in the field of view of the imaging system. In some embodiments, the object is a medical system or device, such as a catheter, endoscope, laparoscope, or any other object that the shape sensor is capable of characterizing. The system may also include a pose sensor 160 connected to an appropriate moving portion of the imaging system as disclosed above. In the depicted embodiment, the various components such as the shape sensor 190, the pose sensor 160, and the detector 116 may be operatively coupled with the control system 120 such that signals from these different components may be output to the control system 120 for use in the various embodiments disclosed herein. In some embodiments, the control system 120 may include at least one processor 122 and at least one memory 124. In some embodiments, the memory may be non-transitory computer readable memory 124 that includes computer executable instructions thereon that when executed by the at least one processor may perform any of the methods disclosed herein.

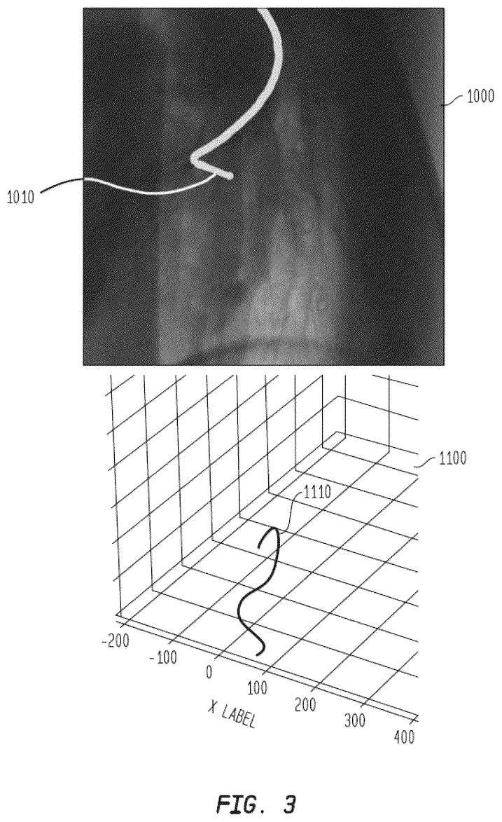

FIG. 3 illustrates how a shape sensor may be used to determine a location or pose of one or more portions of an instrument disposed within the field of view of an imaging system. In the depicted embodiment, an illustrative flexible, elongate device 1010 (e.g., a catheter) including a shape sensor, not depicted, is visualized in a captured image 1000 of human anatomy. A corresponding shape of the flexible, elongate device relative to a reference frame of the imaging system is shown in the corresponding three-dimensional graph 1100 where the location and pose of the various intermediate portions of the flexible, elongate device may correspond to the integrated poses of the intermediate portions of the flexible, elongate device. As elaborated on further below, a two-dimensional projection of the measured three-dimensional shape, or location of a portion of the imaged three-dimensional object, may be correlated with a corresponding location of these features in the captured two-dimensional image. For example, a known location of the distal end portion of the flexible, elongate device in the reference frame of the imaging system may be correlated with location of the distal end portion of the flexible, elongate device in the captured image to determine a pose of that image as elaborated on further below. While a flexible, elongate device is described relative to the figure, any appropriate type of object and corresponding sensor capable of measuring a location or pose of the object within a reference frame of the imaging system may be used.

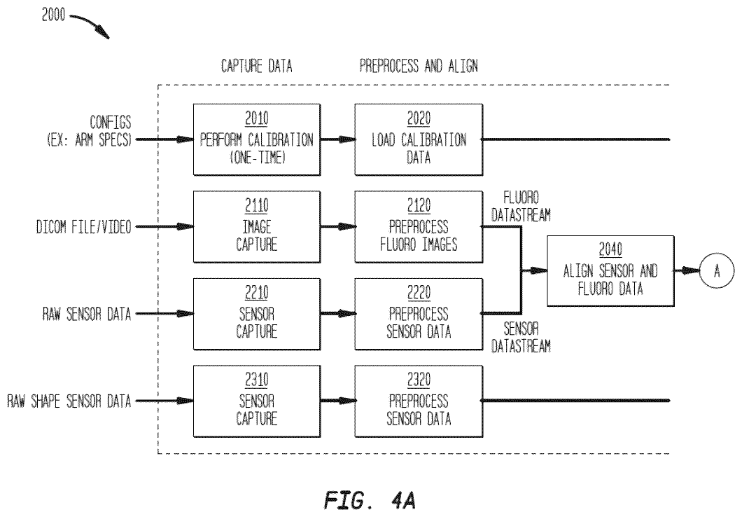

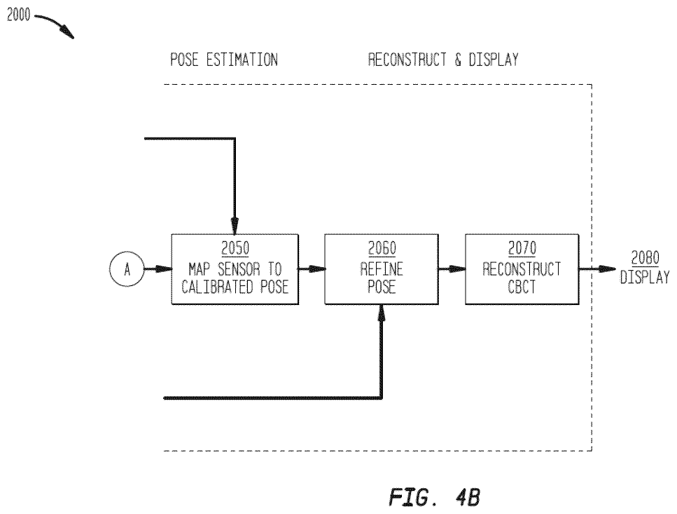

FIGS. 4A-4B depict a flowchart illustrating a method 2000 used to estimate the poses associated with a captured image stream from an imaging system and reconstruction of a three-dimensional structure based on the estimated poses and image stream. FIG. 4A is the first part of the flowchart and FIG. 4B is the second part of the flowchart continuing from indicator A shown in FIG. 4A. In some embodiments, the depicted method may be implemented using the processes, systems, and control systems described above. The method 2000 is illustrated as a set of stages, blocks, steps, operations, or processes. Not all of the illustrated, enumerated operations may be performed in all embodiments of the method 2000. Additionally, some additional operations that are not expressly illustrated in FIGS. 4A-4B may be included before, after, in between, or as part of the enumerated stages. Some embodiments of the method 2000 include instructions corresponding to the processes of the method 2000 as stored in a memory. These instructions may be executed by a processor, like a processor of a controller or control system.

In some embodiments, a pose sensor, such as that described above, may optionally be used to determine an initial estimate of the pose of the source 114 and detector 116 of the C-arm. In some embodiments, other types of devices can replace the sensor to provide this information, including optical tracking sensors, cameras, encoders, hall sensors, distance sensors, or any other suitable device or system.

Some embodiments of the method 2000 may begin with stages of capturing data, which may include stages 2010, 2110, 2210, and 2310, as elaborated on below. In some embodiments, it may be desirable to know when to start data capture of stages 2010, 2110, 2210, and 2310. In one embodiment, a physical button may be pressed by an operator to indicate that a scan is going to be performed using a C-arm imaging system. Alternatively, a device and/or software application can detect the start of a scan from the video capture or based on data from the pose sensor (e.g., exceeding a threshold change in pose). In some embodiments, the data may be passed through a smoothing filter for this detection, which may reduce false positives. In some embodiments, other sensors and/or algorithms can be used to detect the start of motion. Alternatively or additionally, detection may be performed by detecting an X-ray beam-on signal from the C-arm imaging system 100, which may contain a radiation signal. In some embodiments, when the scan begins, a signal may trigger the beginning of sensor and video recordings. Regardless of how the process is initiated, after triggering the start of data capture, the operator may rotate the C-arm manually to complete the scan.

In addition to starting data capture, it may be desirable to determine when a scan is completed and data capture should be terminated. For example, in one embodiment, the various sensor data may continue to be recorded until an appropriate input is received indicating the end of rotation and/or imaging with the C-arm. For example, a user input, the termination of image capture, turning an x-ray source off, and/or a change in the pose of the imaging system being below a threshold for a predetermined time period, and/or any other appropriate input may be used to determine when to terminate data capture.

Various types of feedback may be provided to a user during scanning. For example, in some embodiments, the system may monitor the video images streamed to see if any images are over-exposed and may adjust display settings to include all structures as much as possible. In other embodiments, the system may check for user errors. For example, if the user is rotating the C-arm but not stepping on the imaging or fluoroscopic pedal, no images will be live, or if the user is stepping on the pedal but not rotating the C-arm, the images will not change. The system may provide an output to the user indicating such occurrences. In yet another embodiment, if any irregular pattern is detected by sensors (e.g., too fast, too slow, not enough angles, etc.), this information can potentially be output from the system to the operator to inform the operator that they should adjust their speed or add more rotations, or make any other suitable adjustment. Of course, other appropriate types of feedback may be provided to an operator as the disclosure is not limited in this fashion.

In stage 2010, calibration of a pose sensor may be performed, which may be done one time. In some embodiments, this one-time calibration may be used to improve reconstruction quality. In some embodiments, this calibration may include placing a phantom with easily identifiable markers of known shape in the field of view of the imaging system. In some embodiments, a scan may then be performed, recording data both from an optional pose sensor and video data from the imaging system. In some embodiments, the calibration is used to determine the approximate trajectory of both the source and detector of an imaging system during scanning.

In stage 2110, images of an object may be captured. For example, the images may be X-ray fluoroscopic-images captured by a C-arm imaging system as described above. Additionally, the object may be a human subject, or portion of the subject (e.g., an organ of the subject). As noted above, in some embodiments, the received images are taken at different poses relative to the object, such as from different positions and orientations that the operator moves the manual C-arm through. In some embodiments, the different poses may correspond to different orientations (e.g., angles) of the system. However, embodiments in which the different poses are characterized as changes in both orientation and position are also contemplated. In either case, the captured stream of sequential images may be output to a corresponding control system, or other computing system, including a processor configured to perform the methods disclosed herein.

In stage 2210, data from the pose sensor may optionally be captured. As noted previously, this sensed pose data may be used to determine an initial estimate of the poses of the separate images of the captured stream of images. For example, time data associated with the different sensed poses and the captured images may be used to correlate the estimated poses with the corresponding captured images to provide the initial estimated poses.

In stage 2310, data from a shape sensor may be captured. For example, data from a flexible, elongate device, or other medical instrument, with shape-sensing may be captured. As noted previously, the shape sensor data may provide information related to a shape of one or more portions of the medical instrument within a reference frame of the imaging system. In one such embodiment, a pose of a distal end portion of the catheter, or other medical instrument, may be known within the reference frame of the imaging system.

After capturing the initial data, the method 2000 may then proceed to stages for preprocessing of the captured data, which may include stages 2020, 2120, 2220, and 2320 in FIG. 4A. In stage 2020, the calibration data from stage 2010 may be loaded by the processor.

In stage 2120, the images captured in stage 2110 (e.g., X-ray fluoroscopic-images) may be subject to any appropriate preprocessing including, but not limited to, contrast adjustment, image correction, filtering, cropping, and/or any other appropriate type of image preprocessing.

In stage 2220, the optional pose sensor data captured in stage 2210 may be preprocessed. The pose sensor data may correspond to sensor inputs related to a pose of the imaging system during image capture. Appropriate types of preprocessing for the pose sensor data may include, but is not limited to, signal averaging, filtering, smoothing, and/or any other appropriate type of preprocessing that may be desired for the sensed pose data.

In stage 2320, the shape sensor data captured in stage 2310 may be preprocessed. Appropriate types of preprocessing for the pose sensor data may include, but is not limited to, integration of the sensor data to determine one or more locations of one or more portions of an objection with a reference frame of the imaging system. Other appropriate type of preprocessing of the shape sensor data may also be used.

The method 2000 may then proceed to stage 2040 for data alignment of the preprocessed data. In stage 2040, the received image data may be aligned with the sensor data from the pose sensor. For example, the image data preprocessed in stage 2120 may be aligned with the sensor data preprocessed in stage 2220.

The method 2000 may then proceed to stages of pose estimation, which may include stage 2050, see connector A in FIGS. 4A and 4B. In stage 2050, the aligned sensor data may be mapped to a calibrated pose. For example, the sensor data aligned in stage 2040 may be mapped to calibration data loaded in stage 2020, if calibration was performed, in order to determine a more accurate pose estimate for the different images of the image stream.

In some embodiments, the sensed pose given by the optional pose sensor may be used to determine the initial pose estimate associated with the different images in 2050. For example, if the rotation of the C-arm is only about one axis, rotation information from the pose sensor may be mapped to a single angle. For example, the rotation may be mapped to an axis-angle representation, and the axis may be constrained. In such embodiments, the angle may then represent how much the C-arm has rotated about the axis.

As another example, a frame at the origin may be rotated by the three-dimensional rotation and then translated out by the C-arm radius. In such embodiments, the points of these frame locations can then be constrained to a sphere in three dimensions, and the angles formed by each pair of adjacent points may represent how much the C-arm has rotated.

In yet another embodiment of stage 2050, the initial estimated poses of the corresponding images of the image stream may correspond to angular positions that are evenly distributed along an expected trajectory over the rotational range of the imaging system. For example, a system with a rotational range of 180 degrees may be estimated as having an image stream that includes images evenly distributed across this rotational range of the system extending from 0 to 180 degrees (e.g., for 100 frames taken over 180 degrees, each frame may be estimated as being 1.8 degrees from its neighboring frames). In some embodiments, a greater or smaller range of rotation may be used depending on the system being used. Additionally, instances in which the initial estimates are random numbers, all zeros, or any other appropriate initial estimate may also be used.

The initial estimates of poses using the pose sensor, or from any other initial estimation technique, may be inaccurate due to the variability in manual rotations of the C-arm, sensor errors, and/or other error sources. Thus, after estimating the poses of the images of the image stream, the method may proceed to stage 2060 where the poses of the images may be further refined to improve their accuracy. As noted previously, using information related to the shape, location, and/or pose of a portion of an object being imaged may be used to improve the estimated poses using individual pose corrections for each frame that can account for differences in manual rotation trajectories. For example, refinement of the pose may use at least a portion of an object of known shape and/or location in the frame of reference of the imaging device and within a field of view of the images of the image stream. As a result, the refined poses of the individual images of the image stream may be more robust and accurate.

In one possible example of stage 2060, a portion of an object of known shape and/or location may correspond to a medical instrument (e.g., a distal end portion of a catheter or other instrument disclosed herein) present within the field of view of the imaging system. Using an appropriate shape sensor associated with the medical instrument, the shape of the one or more portions of the medical instrument relative to a reference frame of the imaging system may be determined. The initial pose estimates along with the known shape and/or location of at least a portion of the medical instrument can be used to determine the error in the estimated poses. Specifically, the measured shape and/or location of one or more portions of the object may be projected into a two-dimensional image using the estimated poses associated with each image of the stream of images. The location of the one or more portions of the object in the projected images may be compared to the location of the one or more portions of the object in the original images to determine the error. These determined errors may then be used to determine updated estimates for the pose of each of the images of the image stream. For example, in some embodiments, refined and more accurate poses can be found by minimizing the errors between the estimated position of the one or more portions of the medical instrument and where it is actually seen in the received images in the various poses. Appropriate methods for determining the poses may include but are not limited to: alignment between identified features in the images and a projected image of the object of known shape and/or location; bundle adjustment; a trained statistical model configured to identify appropriate poses based at least in part on a location and/or shape that at least a portion of the object; and/or any other appropriate type of method for determining the appropriate poses based on the re-projected images and the original corresponding images of the image stream.

In the various embodiments disclosed herein, an estimated and refined pose information may include extrinsic pose parameters such as position and/or orientation from which the images are taken. In some embodiments, the intrinsic parameters such as the dimensions associated with the source and detector used for imaging may be known and input to the appropriate algorithms. However, embodiments in which one or more of these intrinsic parameters are included in the estimated and refined poses to be determined by the processes and systems disclosed herein are also contemplated as the disclosure is not limited in this fashion.

After determining the poses, the method 2000 may either store the poses and image stream for subsequent use, or it may proceed to reconstruction at stage 2070. In stage 2070, the three-dimensional structure may be reconstructed using the refined pose estimation from stage 2060 and the stream of images. As the poses are now known, any appropriate reconstruction method used in the art may be used including, but not limited to, Filtered Backprojection (FBP), Simultaneous Iterative Reconstruction Technique (SIRT), Simultaneous Algebraic Reconstruction Technique (SART), Iterative Reconstruction Technique (ART), Conjugate Gradient Least Squares (CGLS), FDK, ADMM Total Variation, ADMM Wavelets, ordered subset expectation maximization (OSEM), Statistical Image Reconstruction (SIR), Coordinate-ascent algorithms, Expectation-maximization algorithm (EM), and/or any other reconstruction technique.

After reconstructing the three-dimension object, the method 2000 may optionally proceed to displaying information at stage 2080. In stage 2080, information related to the reconstructed three-dimensional object may be displayed to an operator of the system. This may include displaying three-dimensional renderings, segmentation, and/or any other appropriate type of information related to the reconstructed three-dimensional object.

In some embodiments, at least some portions of stages 2060 and 2070 may be repeated as needed, as described herein. Although not shown in method 2000, a check may be made whether the reconstruction has completed (e.g., convergence has been reached, at which the difference between the received images and the projected images is within a threshold). If the reconstruction has not completed, the method 2000 may return to at least some portion of stage 2060. Alternatively, if the reconstruction has completed, the method 2000 may then end or repeat as needed.

In the above embodiments, the poses have been refined from an initial estimate of the poses of the received images. However, in some embodiments, it may be desirable to proceed directly from stage 2050 where the estimated pose is determined based on one or more sensed pose parameters from an addon pose sensor and an optional calibration to reconstruction at stage 2070. In such an embodiment, the initial estimated pose from the pose sensor data may be considered accurate enough to permit reconstruction to proceed based on the time coordinated images and pose information. Thus, it should be understood that the current disclosure may be implemented with or without further refining of the pose information related with the captured image stream.

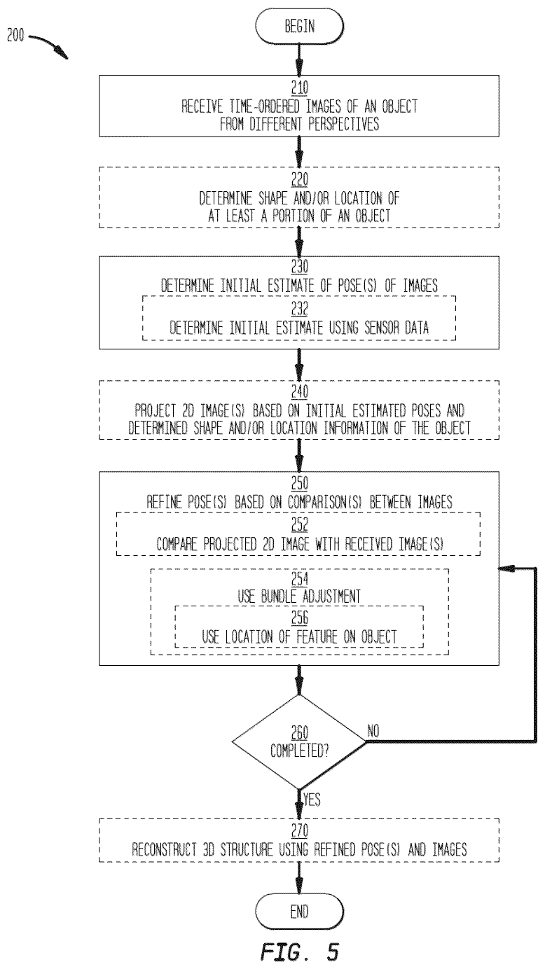

FIG. 5 is a flowchart illustrating a method 200 used to reconstruct a three-dimensional structure, according to an embodiment of the present disclosure. In some embodiments, the depicted method may be implemented using the processes, systems, and controllers described above. The method 200 is illustrated in FIG. 5 as a set of stages, blocks, steps, operations, or processes. Not all of the illustrated, enumerated operations may be performed in all embodiments of the method 200. Additionally, some additional operations that are not expressly illustrated in FIG. 5 may be included before, after, in between, or as part of the enumerated stages. Operations may also be performed in orders different from those shown. Some embodiments of the method 200 include instructions corresponding to the processes of the method 200 as stored in a memory. These instructions may be executed by a processor, like a processor of a controller or control system.

Some embodiments of the method 200 may begin at stage 210, in which time-ordered images of an object taken by an imaging device at different poses may be received. In some embodiments, the object may be a human patient or subject and/or an organ of the patient or subject. In some embodiments, the images of the object may be X-ray images. In some embodiments, the images of the object may be taken from different perspectives, each perspective corresponding with a pose of the imaging device relative to the object. In some embodiments, the plurality of images may be a series of sequential images that are taken at a plurality of sequential poses that are located along a path of motion of a detector of an imaging system relative to an object located within a field of view of the detector. In some embodiments, at least one object of known shape and/or location relative to a reference frame of the imaging system may be present in the field of view of the images. For example, a medical instrument including a shape sensor may be present within the field of view of the imaging system during imaging of a subject.

The method 200 may then optionally proceed to stage 220, in which the shape and/or location of at least a portion of the object may be determined. For example, a processor may receive a sensed or otherwise determined location of at least one portion of the object relative to a reference frame of the imaging system. In other embodiments, the processor may receive a sensed shape of the at least one object relative to a reference frame of the imaging system.

The method 200 may then proceed to stage 230, in which an initial estimate of the poses of the individual images of the image stream may be determined. For example, a processor may determine an initial estimate of at least one pose of at least one of the received images.

In some embodiments, stage 230 may optionally include stage 232, in which the initial estimate of poses may be determined using sensor data, such as is described above. For example, the processor may determine the initial pose estimates based at least in part on data from a pose sensor such as an inertial measurement unit, an accelerometer, a gyroscope, a magnetometer, or any other appropriate pose sensors attached to the imaging system during capture of the received images.

The method 200 may then optionally proceed to stage 240, in which two-dimensional image(s) may be projected based on the initial estimated poses and the shape and/or location information related to the object noted above. For example, in some embodiments, the location and/or shape information determined relative to the one or more portions of the object (e.g., a medical instrument) may be projected into a two-dimensional image using the pose estimates. Examples of this process are described further above relative to FIGS. 4A and 4B.

The method 200 may then proceed to stage 250, in which the pose(s) may be refined based on at least one comparison between the projected images and the corresponding images of the image stream. In some embodiments, stage 250 may include stage 252, wherein the comparison comprises comparing at least one projected two-dimensional image of a shape and/or location of one or more portions of the object with at least one of the received images. For example, the comparison may comprise an alignment of data from the at least one projected two-dimensional image with the received images. Alternatively or additionally to stage 252, stage 250 may include stage 254, wherein the processor may use bundle adjustment to refine the at least one pose based on the at least one object of known shape and/or location. In some embodiments, stage 254 may include stage 256, where the processor may use the location of one or more portions of the object when refining the at least one pose with bundle adjustment.

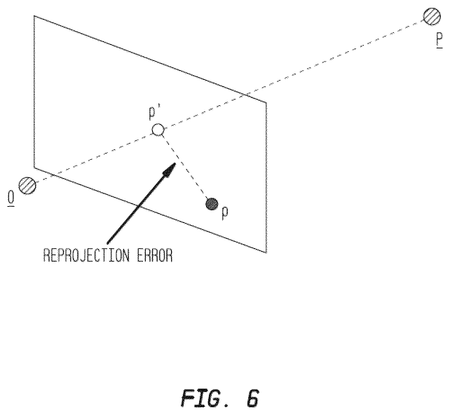

FIG. 6 shows an example of bundle adjustment. In FIG. 6, P is an estimated point in the real world, p′ is where that point would be seen if a camera were at a specific location relative to the position of a source at O used to create the signal detected by the camera, and p is where the point is actually viewed from. In some embodiments, bundle adjustment includes a non-linear optimization that tries to correct points and cameras (for example, X-ray imaging positions) by minimizing the reprojection error which can be used to refine the pose estimates. However, as noted previously, other optimization techniques may also be used.

At stage 260, in some embodiments, at least some portions of stage 250 may be repeated as needed, as described above. For example, if the poses have converged to within a desired threshold accuracy, the method 200 may then proceed to stage 270 with the refined poses for reconstruction. Alternatively, if the refined poses still need additional refinement, the method 200 may return to at least some portion of stage 250 until the poses exhibit a desired accuracy.

At stage 270, the images may be reconstructed to provide a three-dimensional reconstruction of the image streams including the object. This reconstruction may be conducted using the refined pose(s) and images of the image stream as described above. For example, the processor may reconstruct a three-dimensional structure using the refined poses and the received images of the image stream. The poses, reconstructed three dimensional structures (including the reconstructed object), image stream, and/or any other appropriate information may either be stored in memory for future recall and use, displayed to an operator as detailed above, or used for any other appropriate application.

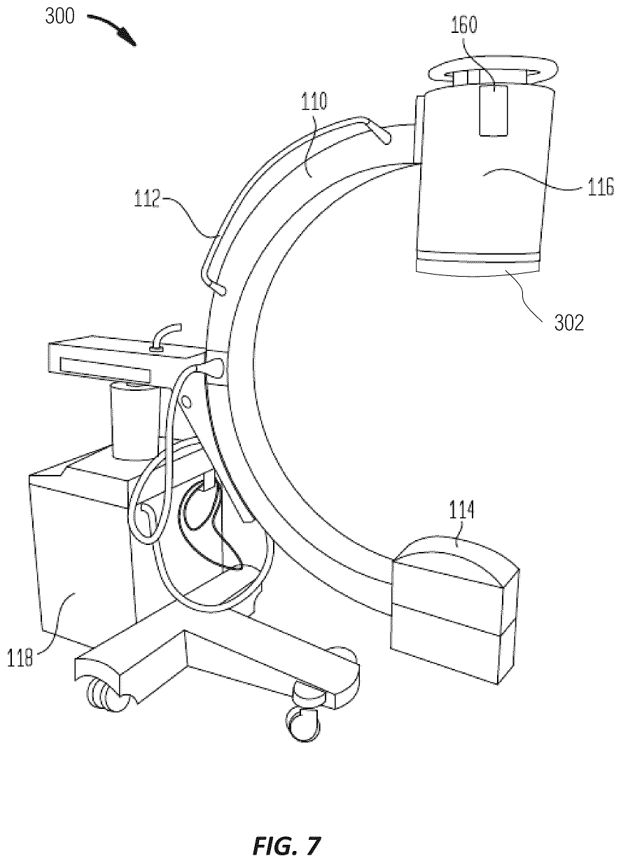

C-arm systems, particularly those that include an image intensifier detector, may be subject to spatial distortion. In some examples, spherical distortion (e.g. radial, pincushion, and/or barrel distortion) may be caused by optical lenses and may be relatively consistent with changes in the C-arm pose. In some examples, sigmoid distortion (e.g., S-distortion) may be caused by external magnetic fields, and the distortion field may change with the C-arm pose. Without compensation, these forms of distortion may result in inaccurate pose determination and warp three-dimensional reconstructions generated by the C-arm. Determining a set of distortion parameters for the C-arm system or for particular configurations of the C-arm system may allow for compensation of the distortions. In some examples, an object of known shape (e.g., object 1010) in the field of view of the C-arm detector may be used to optimize both pose and distortion parameters but using a common object to optimize both parameters may be difficult. Using different objects of known shape and/or configuration may allow the optimizations to be separated and may result in more accurate determinations of pose and distortion parameters. FIG. 7 illustrates a C-arm imaging system 300 including an object 302 that may be used for calibrating distortion parameters. The system 300 may be similar to the system 100, with differences as described. In this example, an object 302 may be attached to the C-arm 110. The object 302 may have known characteristics such as a known shape and/or location, such as a known fiducial pattern, and may be used to calibrate distortion parameters for the C-arm. The object 302 may be fixed or coupled to the C-arm 110 such that the object rotates with the C-arm and remains in the same position in the C-arm field of view for all generated images. In some examples, the object 302 may be attached to and rotate with the detector 116.

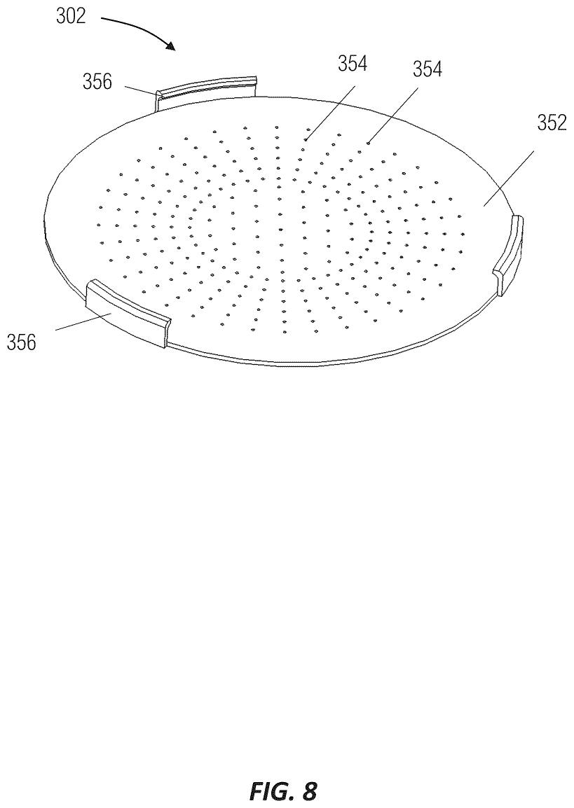

FIG. 8 is a top view of the object 302. The object 302 may include a platform 352 and a set of fiducials 354. One or more attachment devices 356, such as clamps, clips, threaded connectors, or other mechanical fixtures, may be configured to removably or permanently couple the object 302 to the detector 116. The fiducials 354 have a fixed position and orientation relative to the detector 116. As the detector 116 is rotated, the position of the fiducials 354 in the generated images remains constant while the position and orientation of an object 1010 in the field of view of the detector 116 changes. The fiducials 354 may be used to determine distortion parameters, and the object 1010 may be separately used to determine pose parameters. The distortion parameters may be used to correct the distortion and generate an un-warped image or three-dimensional reconstruction. In some examples, the platform 352 may be formed from a metal material, and the fiducials 354 may be a set of apertures through the platform 352. The metal material may dim the field of view, except at the location of the fiducials. In some examples, the platform 352 may be formed from a radiolucent material such as plastic, and the fiducials 354 may be formed from a radiopaque material, such as metal spheres. The metal spheres may have a constant position and orientation in the generated images. In some examples, the fiducials 354 may have a different shape from the object 1010 and thus may be distinguishable based upon shape in the generated images. In other examples, the fiducials 354 may have the same shape as the object 1010 but may be distinguishable from the object 1010 in successive images because the fiducials 354 are position invariant in the generated images.

One or more elements in embodiments of the current disclosure may be implemented in software to execute on a processor of a computer system including the control systems disclosed herein. When implemented in software, the elements of the embodiments of the disclosure are essentially the code segments to perform the necessary tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit, a semiconductor device, a semiconductor memory device, a read only memory (ROM), a flash memory, an erasable programmable read only memory (EPROM), a floppy diskette, a CD-ROM, an optical disk, a hard disk, or other storage device. The code segments may be downloaded via computer networks such as the Internet, Intranet, etc.

Note that the processes and displays presented may not inherently be related to any particular computer or other apparatus. The structure for a variety of these systems appears as elements in the claims. In addition, the embodiments of the disclosure are not described with reference to any particular programming language. It will be appreciated that a variety of programming languages may be used to implement the teachings of the disclosure as described herein.

While the present teachings have been described in conjunction with various examples, it is not intended that the present teachings be limited to such examples. On the contrary, the present teachings encompass various alternatives, modifications, and equivalents, as will be appreciated by those of skill in the art. Accordingly, the foregoing description and drawings are by way of example only.

1. A three-dimensional structure reconstruction system comprising:
at least one processor configured to:
receive a time-ordered plurality of X-ray images of a subject, wherein the plurality of X-ray images is taken at a plurality of poses relative to the subject, wherein at least one of the plurality of X-ray images depicts at least one object of known shape and/or location;
determine an initial estimate of a pose of at least one of the plurality of X-ray images; and
refine the initial estimate of the pose based on at least one comparison of the at least one of the plurality of X-ray images with at least one projected image determined from the initial estimate of the pose and the object of known shape and/or location.

2. The system of claim 1, wherein the at least one processor is further configured to reconstruct a three-dimensional structure using the refined initial estimate of the pose and the plurality of X-ray images.

3. The system of claim 1, wherein the at least one processor is further configured to determine the initial estimate of the pose based at least in part on data from at least one of an inertial measurement unit, an accelerometer, a gyroscope, or a magnetometer attached to an imaging system during capture of the plurality of X-ray images.

4. The system of claim 1, wherein the at least one processor is further configured to determine the initial estimate of the pose using a uniform distribution of the plurality of poses across a range of motion of an imaging system used to take the plurality of X-ray images.

5. The system of claim 1, wherein the at least one projected image includes at least one projected two-dimensional image of the shape and/or location of at least a portion of the at least one object and the at least one comparison comprises comparing the at least one projected two-dimensional image with at least one of the plurality of X-ray images.

6. The system of claim 5, wherein the at least one comparison comprises an alignment of data from the at least one projected two-dimensional image with the plurality of X-ray images.

7. The system of claim 1, wherein the at least one processor is further configured to use bundle adjustment to refine the initial estimate of the pose based at least in part on the object of known shape and/or location.

8-9. (canceled)

10. The system of claim 1, wherein the at least one processor is further configured to receive a sensed shape of the at least one object.

11. The system of claim 1, wherein the at least one object of known shape and/or location includes a first object of known shape and/or location and a second object of known shape and/or location and wherein the processor is further configured to determine a distortion parameter from the second object of known shape and/or location.

12. The system of claim 11, wherein the second object is movable relative to the first object.

13. A method for three-dimensional structure reconstruction, the method comprising:
receiving a time-ordered plurality of X-ray images of a subject, wherein the plurality of X-ray images is taken at a plurality of poses relative to the subject, wherein at least one of the plurality of X-ray images depicts at least one object of known shape and/or location;
determining an initial estimate of a pose of at least one of the plurality of X-ray images; and
refining the initial estimate of the pose based on at least one comparison of the plurality of X-ray images with at least one projected image determined from the initial estimate of the pose and the object of known shape and/or location.

14. The method of claim 13, further comprising reconstructing a three-dimensional structure using the refined initial estimate of the pose and the plurality of X-ray images.

15. The method of claim 13, further comprising determining the initial estimate of the pose based at least in part on data from at least one of an inertial measurement unit, an accelerometer, a gyroscope, or a magnetometer attached to an imaging system during capture of the plurality of X-ray images.

16. The method of claim 13, wherein the determining the initial estimate of the pose includes using a uniform distribution of the plurality of poses across a range of motion of an imaging system used to take the plurality of X-ray images.

17. The method of claim 13, wherein the at least one projected image includes at least one projected two-dimensional image of a shape and/or location of the object and the at least one comparison comprises comparing the at least one projected two-dimensional image with at least one of the plurality of X-ray images.

18. The method of claim 17, wherein the at least one comparison comprises an alignment of data from the at least one projected two-dimensional image with the plurality of X-ray images.

19. The method of any one of claim 13, wherein the method further comprises using bundle adjustment to refine the initial estimate of the pose based on the at least one object of known shape.

20-21. (canceled)

22. The method of claim 13, further comprising receiving a sensed shape of the at least one object.

23. (canceled)

24. The method of claim 13, wherein the at least one object of known shape and/or location includes a first object of known shape and/or location and a second object of known shape and/or location and the method further comprises determining a distortion parameter from the second object of known shape and/or location.

25. The method of claim 24, wherein the second object is movable relative to the first object.
